(19) United States
(12) Patent Application Publication
(10) Pub. No.: US 2009/0252569 A1
(43) Pub. Date: Oct. 8, 2009

(54) System for securing containers with multiple embodiments

(76) Inventor: Peter J. Walker, Westport, CT (US)

Correspondence Address: Peter Walker, 45 Old Road, Westport, CT, 06880, US

(21) Appl. No.: 12/383,302

(22) Filed: Mar. 23, 2009

Related U.S. Application Data
(60) Provisional application No. 61/123,535, filed on Apr. 8, 2008.

(51) Int. Cl. B60P 7/13

(52) U.S. Cl. 410/78

(57) ABSTRACT

A system for locking and unlocking containers to transport modes and other containers comprises an actuating unit in an upper corner fitting of a container, a mechanical connecting means connected to the actuating unit, and guides to route the connecting means from the actuating unit to a rotatable locking leg housed in a lower corner fitting of the container. The twist lock of a lifting spreader engages the upper corner fitting of a container, urging the actuating unit. The connecting means is in turn urged thereby causing the locking leg to rotate.

### CROSS-REFERENCE TO RELATED APPLICATIONS

This application claims benefit of provisional patent application Ser. No 61/123,535, filed 2008 Apr. 8 by the present invention

### BACKGROUND

1. Field of Invention

This invention relates generally to the locking of shipping containers. More particularly, this invention relates to a mechanism for connecting and disconnecting bulk containers to a base, such as, but not limited to, chassis, railcars, ship hatches, airline cargo decks, terminal decks and other containers.

2. Description of Prior Art

When transporting or stacking bulk containers a locking device is needed to secure the containers to a base. The base could be an integral part of a transport vehicle, such as: truck chassis, railcar, aircraft, or ship hatch. Additionally, a base could be an adjacent container, when the containers are stacked onboard ships, rail cars, or in container yards. These locking devices are numerous including: cones, twist locks, lashing bars and other systems. Although these devices and systems are currently used to connect containers to various bases, they posses a number of disadvantages that make them unsafe and inefficient.

Currently a device called a cone is used when connecting containers to a ship's hatch or other containers. Cones come in three forms, manual cones, automatic cones and below deck cones. Cones are generally two tetrahedron shaped objects wherein the bases of the tetrahedrons are rectangular in shape and the bases of the tetrahedrons are base to base, such that the cones, when in an unlocked position, are in the shape of an octahedral diamond. At least one of the tetrahedrons can rotate such that the bases are no longer aligned, and when inserted between container corner castings can connect containers.

Manual cones are inserted into corner castings of a container that will connect to a ship hatch or another container. These cones are inserted into the corner castings manually when a lifting device raises the container off a chassis. The cone is inserted into the corner casting access slot of a container; and the head that is in the access slot is manually turned such that the head is locked into the corner casting. Once the cones are inserted in all four lower corner castings the container is lifted to its position on the ship and lowered onto the deck or another container where the bottom head of the cone mates with the deck or upper corner fittings of a lower container. The bottom head is then manually turned such that the head is locked into the corner casting thereby locking the container to a base.

Manual cones have a number of disadvantages. Cones require manual locking and unlocking, incurring additional labor costs and placing humans in potentially dangerous situations. Additionally, they require personnel to work both on vessels and on the ground, again increasing labor costs. Laborers are required to work around and beneath suspended containers, which weigh many tons even when empty. In addition, when cones are not inserted or turned into the locking position they can become detached from a container causing additional problems, such as an unsecured connection between a container and a base or, when being hoisted by a lifting device, the cone can fall from the container, injuring or killing personnel. Further, a cone is one form of a number of similar locking devices used to secure containers, such that additional equipment and additional purchase and maintenance costs are incurred. Lastly, recent U.S. regulations have required that all cones used at U.S. ports be of the automatic type due to safety considerations, causing the manual cones to be unsuitable for use in the U.S.

Automatic cones are similar to manual cones in design however, when the automatic cones are mated to a base they lock automatically. Although automatic cones eliminate the need to manually lock containers to a base, they still require a manual release, still placing personnel into dangerous work environments. For instance, containers are often stacked five, six or even seven high on board ship hatches, requiring personnel to work at great heights. Furthermore, automatic cones have a number of the disadvantages that manual cones posses, including: requiring personnel to work both on vessels and on the ground, the cones can fall free injuring or killing personnel below, and an automatic cone is one form of a number of similar locking devices used to secure containers such that additional equipment and therefore additional purchase and maintenance costs are incurred.

The twist lock is yet another device that is used to connect containers to a chassis. Twist locks are comprised of a locking pin and a handle. The locking pin has a shaft that runs through the bolster of a chassis, which can rotate. The locking pin also has a head which is rectangular in shape at its base and is cone shaped at its top. Bulk containers have corner castings with access slots at their top and bottom such that when the container is mounted on a chassis the head of the twist lock can mate with the access slot. The access slot is an opening in the corner casting of a container with which the pin head can mate when the pin head is in an open position but cannot mate or disconnect when the pin is in a locked position. When the locking pin mates with the corner casting, a handle connected to the shaft of the locking pin is manually turned, which in turn, twists the pin head inside of the corner casting such that the base portion of the pin head connected to the shaft is now askew in relation to the opening in the corner casting access slot, such that the container cannot be disconnected from its base.

Although twist locks address some of the limitations of the previous devices, they also posses a number of disadvantages. Still, the system requires a person to manually open and close the twist locks in order to connect or disconnect a container from its transport base. The manual requirement can put a person in a dangerous work environment where heavy machinery is lifting tons of equipment thereby putting an individual at risk of injury or death.

A second disadvantage of twist locks is the procedures that are adopted to prevent personnel from having to unlock containers from their bases in dangerous environments. A common practice is to require personnel to unlock containers from a chassis as the container enters a yard to prevent them from having to do so around heavy machinery or suspended containers. This method can create a number of dangerous situations in a yard. First, the container is no longer connected to the chassis, it is merely resting on the chassis. If an accident were to occur, the container is not connected to chassis, causing an unpredictable and potentially dangerous situation. Additionally, while driving around a yard, the twist locks often turn accidentally into the locked position requiring the driver to exit the safety of his vehicle to reopen the twist lock, thereby defeating the goal of the procedure. It is not uncommon for lifting devices, such as top picks and cranes, to drag or lift the truck along with the container. These are dangerous situations for drivers and anyone else that might be in the area. A third disadvantage is that a twist lock is again one form of a number of similar locking devices used to secure containers such that additional equipment and therefore additional purchase and maintenance costs are incurred.

Another disadvantage of current methods of securing containers to transport modes relates to the rail industry. When containers are stacked one or two high on rail cars, the lower container simply sits in the well of the rail car and has no means of being connected to the car. This is because there is no way to access the lower corner fittings of a container that is sitting in the well of the rail car. As a result, there is no way to manually unlock a manual or automatic cone or twist lock.

An additional disadvantage of these devises is the number of different locking devices utilized to perform a single function, connecting or disconnecting container from a base. A single, fully automatic, device should be used to connect containers to chassis, railcars, ship hatches or other containers to improve safety and efficiency between different transport modes.

Another disadvantage of these devices is that they adversely effect crane cycle times by 15 to 20% during vessel loading and discharging operations.

Inventions have been developed to overcome the above mentioned problems including Del Aqua's in 1982 (U.S. Pat. No. 4,341,495) and Cain's in 1976 (U.S. Pat. No. 3,980,185) These prior art forms however were not commercially viable; because the components of the inventions are intrusive into the interior space of a container, susceptible to being damaged by equipment or cargo moving into and out of containers, and would require modifications to the doors of a container. Also, these inventions require all four upper corner castings of a container to be engaged by rotatable twist locks of a spreader which is not possible when using machines which only engage two of the upper corner castings or sites that use fork lifts to lift containers. Lastly, the number of moving parts that comprise these are forms would be difficult and expensive to maintain in a fleet of containers spread around the world. In another invention by Walker in 1992 (U.S. Pat. No. 7,014,234), the disadvantages of Del Aqua's and Cain's are overcome, however this prior art from has a disadvantage caused by the non-standardized depth of twist locks used to connect containers together on ships.

It is common practice in container yards to simply stack containers in piles without securing them to one another, because it is not required by federal or state safety regulations. Additionally, equipment costs are prohibitive; cones are provided by vessels, not stevedoring companies or container yards. The additional labor required to set, lock and unlock connecting devices is also costly.

There are hazards inherent by not connecting the containers together while in a stacked configuration, such as building a disorderly pile. While one container is being added to a stack of containers, the container being stacked may nudge another container in the stack, causing it to fall. The fallen container may not be obvious to the operator of the lifting device. For obvious reasons, this is an extremely undesirable and dangerous situation, potentially causing great damage and injury.

As can be seen by existing solution attempts, the problem of providing a safe, economical, universal, and automatic means to secure containers has not been fully addressed. Existing methods can require placing humans in dangerous situations, require many costly parts, require manual locking and unlocking, and create disorderly piles.

What is needed is a locking device that can safely, securely, and automatically lock and unlock a container from a base quickly, requiring a minimum of direct human manipulation. What is also needed is a locking device that has no detached parts, eliminating that safety concern. What is additionally needed is a locking device that meets current safety standards and regulations. What is further needed, is a locking device that can be engaged on rail cars. What is again further needed is a locking device that does not excessively protrude into the interior cargo space of a container. What is still further needed is a locking device that can be automatically disengaged by the insertion of fork lift tines. What is again needed is a locking device that can enable the lifting of a container by just two of the four upper corner castings. What is also needed is a locking device that can be applied to existing modified containers, without the need to modify supporting equipment. What is finally needed is a locking device that provides a means to stack container in orderly and stable piles.

### OBJECTS OF THE INVENTION

It is a general object of the present invention to provide a container locking device that can safely, securely, and automatically lock and unlock a container from a base quickly, requiring a minimum of direct human manipulation.

It is another object of the present invention to provide a container locking device that is integrated into existing container structure.

It is yet another object of the present invention to provide a container locking device that meets or exceeds current safety standards and regulations.

It is a further object of the present invention to provide a container locking device that can be engaged on ship decks, ship holds, rail cars, airplane cargo decks, truck chassis, other containers, and any number of other container transportation means.

It is yet a further object of the present invention to provide a container locking device that does not excessively protrude into the interior cargo space of a container.

It is another object of the present invention to provide a container locking device that can be automatically disengaged by the insertion of fork lift tines.

It is yet another object of the present invention to provide a container locking device that can enable the lifting of a container by just two of the four upper corner castings.

It is a further object of the present invention to provide a container locking device that can be applied to existing modified containers, without the need to modify supporting equipment.

It is also an object of the present invention to co-exist with current container securing equipment in the field.

It is yet a further object of the present invention to provide a container locking device that provides a means to stack containers in orderly and stable piles.

Other objects and features of advantages will become apparent as the specification progresses and from the claims.

### SUMMARY OF THE INVENTION

In accordance with the present invention, a system for locking and unlocking containers to transport modes and other containers is provided. The present invention is comprised of at least one actuating unit housed in the upper corner fitting of a container, a rotatable locking leg housed in a lower corner fitting of the container and a means to couple the actuating unit and the locking leg. Wherein, the twist lock of a lifting spreader engages the upper corner fitting of a container and therefore the actuating unit and urging the actuating unit in the upper corner fitting. The coupling means is pulled by the urging of the actuating unit, accordingly pulling the locking leg, causing it to rotate to an unlocked position. This corner fitting assembly can be installed on either one or all four corners of the container. The assembly can also be installed between upper and lower corner fittings on containers that have corner fittings between the ends of the containers such as but not limited to 45, 48 and 53 containers.

In an alternate embodiment, horizontal coupling means, couple the lower corner fittings together, so that if a single actuating unit is engaged by a lifting spreader twist lock, multiple locking legs in the lower corner fittings can simultaneously rotate into the unlocked position. At least one of the horizontal coupling means can intersect a tine well. The tension to the coupling means can either be imparted from the actuating unit located in the upper corner fitting, causing one or multiple locking legs to rotate to the unlocked position. Alternatively, if the tine of a fork lift or similar lifting vehicle is inserted into the tine well of the container, the tine will lift the horizontal coupling means intersecting the tine well, tensioning the coupling means, again causing one or multiple locking legs to rotate to the unlocked position.

In addition, the locking leg can be of many shapes and comprised of a single unit or multiple parts so long as the leg stays with the lower corner fitting when lifted by a lifting device, able to withstand the forces, dictated by international standards, to secure a container to its base and is able to mate with and rotate within bases such that when the locking leg is in a locked position the locking leg and access slot of the base are not aligned and therefore cannot separate.

The lower corner fitting can be a single unit or comprised of multiple parts as described in the drawings and text of this application, providing the lower corner fitting can house, support, and allow the locking leg to rotate.

To lock securely to a structure, the locking legs need to engage a base. A base is a vertically directed access slot in a surface such that a locking leg can mate with, rotate in, and lock to the underside of the access slot. For example, a square tube with access slots embedded into the surface of a container yard or access slots in the cargo deck of an aircraft could be a base. Additionally, access slots embedded in chassis or railcars can also be a base.

An alternate design is a base having slotted vertical access openings on both the ceiling and floor of the base such that the base can be used as an adapter to receive and lock to the male locking legs of the present invention and the twist lock devices currently used to lock containers to transport modes such as, but not limited to, chassis.

An additional advantage of the present invention is that a single device will be used to connect containers to bases. This will decrease the purchase and maintenance costs connected to cones and chassis twist locks; again decreasing costs to the transportation industry.

All of the disadvantages of the prior art have been addressed by the present invention. As can be seen in the description, an automatic locking system for cargo containers that requires a minimum of direct human intervention is provided. No personnel is required to directly contact the container at any point during the loading and unloading process, saving both labor and time and reducing exposure to potentially unsafe situations. Additionally, no loose parts are required, reducing the chance of falling objects resulting in injury. The present invention also enables the industry to meet safety standards. A secondary safety related advantage of the present invention will be a decrease in the costs associated with on the job injuries that occur around container operations. These decreased costs will be realized by the transportation industry and ultimately consumers.

### BRIEF DESCRIPTION OF THE DRAWINGS

FIG. 1 is a perspective view of the present invention installed on a container, being stacked by a spreader

FIG. 2 is a cross-sectional side view of a cargo container, showing the present invention.

FIG. 3a-d views, of three embodiments of an actuating unit

FIG. 4a-h are views of one embodiment of a locking mechanism

FIG. 5a-c are perspective views of a base

FIG. 6a-b are operational drawings of a spreader twist lock as it mates with an upper corner casting and causes locking legs of lower corner castings to rotate.

### DESCRIPTION OF THE PREFERRED EMBODIMENTS

The detailed description set forth below in connection with the appended drawings is intended as a description of presently-preferred embodiments of the invention and is not intended to represent the only forms in which the present invention may be constructed and/or utilized. The description sets forth the functions and the sequence of steps for constructing and operating the invention in connection with the illustrated embodiments. However, it is to be understood that the same or equivalent functions and sequences may be accomplished by different embodiments that are also intended to be encompassed within the spirit and scope of the invention.

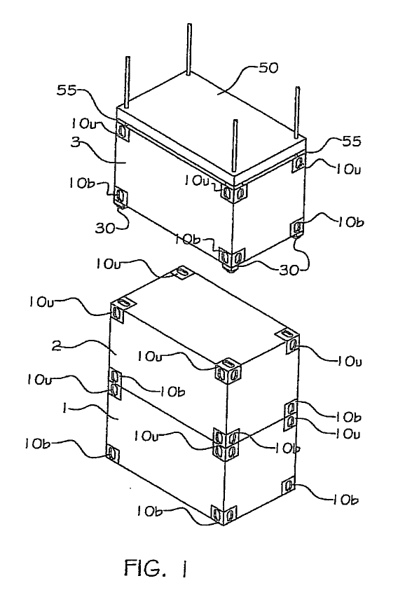

As can be seen in FIG. 1, container 1 and container 2 are stacked, one on top of the other and a third container 3 is suspended above the stacked containers by a lifting spreader 50, in preparation to stack the third container 3. Each container has a total of eight corner fittings, four lower corner fittings 10b and four upper corner fittings 10u where the upper corner fittings 10u of the lower containers 1 serve as bases for the containers on top of them.

The four locking legs 30 of the third container 3 are aligned with the four corner fittings 10u of the upper stacked container 2. As the third container 3 is lowered onto the upper stacked container 2, the locking legs 30 are guided into the corner fittings 10u. The locking legs 30 of the third container 3 will return to a locked position when the lifting spreader 50 has lowered the third container 3 onto the upper stacked container 2 and disengages from the corner fittings 10u of the third container 3, causing the third container 3 to be locked to the now middle container 2. The third container 3 is then restricted in movement. This particular action of locking will be discussed in further detail in the proceeding description.

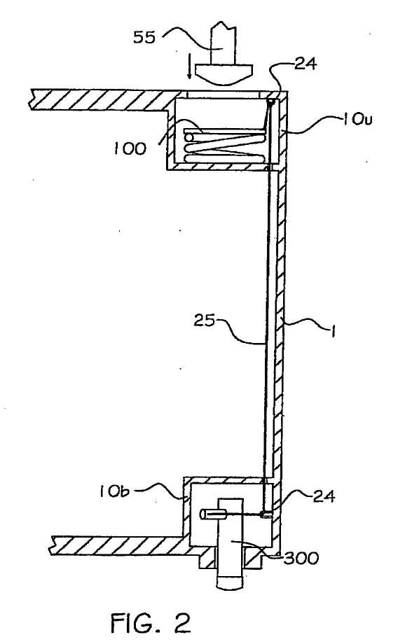

Looking more particularly at FIG. 2, a cutaway of a container more clearly illustrates the present invention. At least one of the upper corner fittings 10u houses an actuating unit 100 and a guiding eye 24. The guiding eye 24 can be any number of pivoting means enabling a change in the direction of a force applied to the vertical connecting line 25, such as a pulley, eyelet, or other similar devices. Additionally, the guiding eye 24 can be attached to the corner fitting 10u or to any other appropriate structure found within or around the container 1.

A vertical connecting line 25, having one end attached to the actuating means 100, runs through the guiding eye 24, pivoting down and exiting the upper corner fitting 10u. The vertical connecting line 25 traverses the height of the container, enters the lower corner fitting 10b, pivots at the second guiding eye 24, and is attached to a locking mechanism 300. The vertical coupling means 25 can be any number of translational coupling devices, such as a cable or a rigid coupler utilizing a mechanism other than the guiding eye 24.

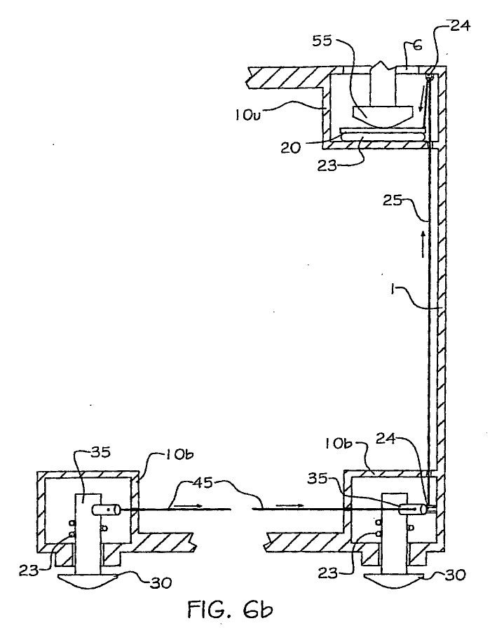

Still referring to FIG. 2, as the actuating unit 100 is engaged by a lifting spreader twist lock 55, the vertical coupling means 25 is pulled accordingly, pivoting at the upper guiding eye 24, and causing a general upward movement in the vertical coupling means 25. The vertical coupling means 25 is again pivoted at the lower guiding eye 24, and in turn, imparts a rotational motion to the locking mechanism 300, causing it to move into the unlocked position as can be seen in FIG. 6a. In a similar, but opposite manner, when the lifting spreader twist lock 55 disengages from the actuating unit 100 the tension on the vertical coupling means 25 is reduced, allowing a torsional return means 47 to impart a rotational motion on the locking mechanism 300, causing it to return to the locked position as is shown in FIG. 6b.

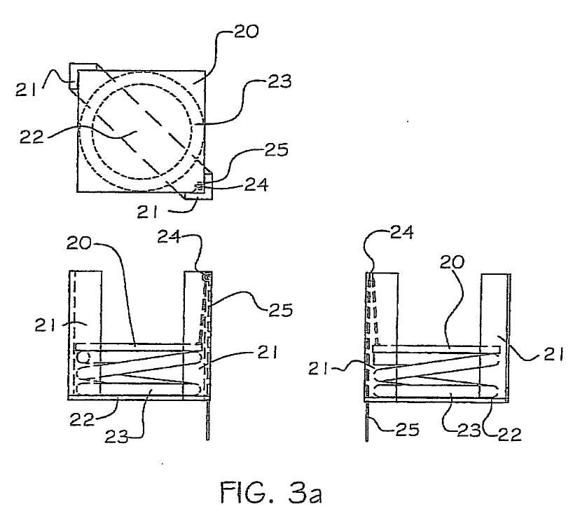

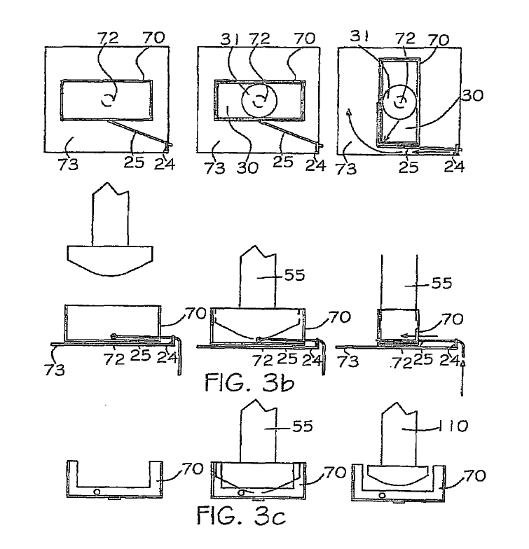

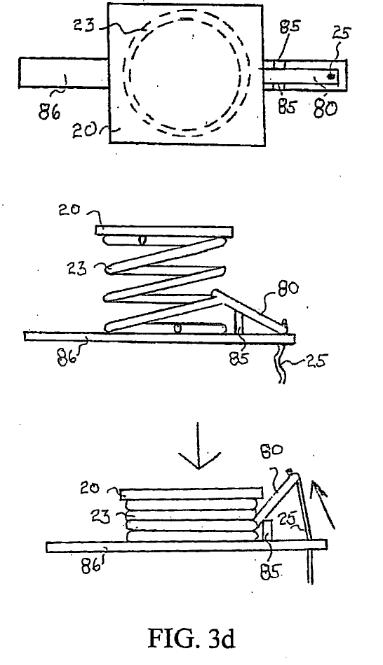

FIG. 3a shows one embodiment of an actuating unit 100 comprising a compression plate 20, compression plate guides 21, a base plate 22 and a torsional return means 23. When the lifting spreader twist lock 55 engages this embodiment of the actuating unit 100 the lifting spreader twist lock 55 forces the compression plate 20 and torsional return means 23 downward as is shown in FIG. 6b. The vertical coupling means 25 is pulled downward accordingly, pivoting at the guiding eye 24, and causing a general upward movement in the vertical coupling means 25 which causes the locking leg 30 of the locking mechanism 300 to rotate as is shown in FIG. 6b.

FIG. 3b shows a plan view and a side view of another embodiment of an actuating unit 100 comprising a cup 70 having walls and a floor, which rotates in a generally horizontal plane about a swivel 72. A lifting spreader twist lock 55 can fit within the walls of the cup 70 as is shown in FIG. 3b. The swivel 72 may be connected to a swivel base 73. The vertical connecting means 25 may be connected directly to the cup 70 or to a coupling means attachment means 35 extending in a generally horizontal plane from the cup 70. When the lifting spreader twist lock 55 engages this embodiment of the actuating unit 100 the lifting spreader twist lock 55 engages the cup 70 and as the lifting spreader twist lock 55 rotates, it causes the cup 70 to rotate, as is shown in FIG. 3b. The vertical coupling means 25 is pulled accordingly, pivoting at the guiding eye 24, and causing the locking leg 30 of a locking mechanism 300 to rotate as is shown in FIG. 6b.

Another embodiment of the cup 70 is shown in FIG. 3c. In FIG. 3b, the embodiment of the cup 70 shows the walls of the cup 70 to be solid; in FIG. 3c, the walls of the cup 70 are partial.

A third embodiment of an upper actuating unit 100 is shown in FIG. 3d. This embodiment includes a lever 80, having one end coupled with the vertical coupling means 25. The lever 80 pivots over a fulcrum 85 when the torsional return means 23 is compressed, causing a generally upward movement of the vertical coupling means 25 which causes the locking leg 30 of a locking mechanism 300 to rotate as is shown in FIG. 6b. The fulcrum 85 maybe connected to a fulcrum base 86.

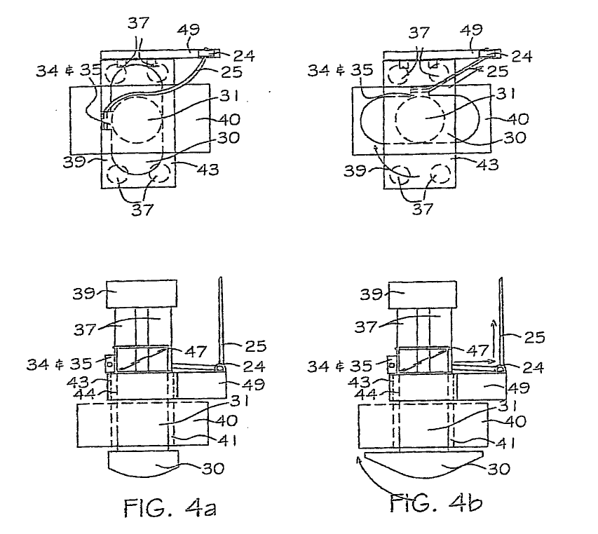

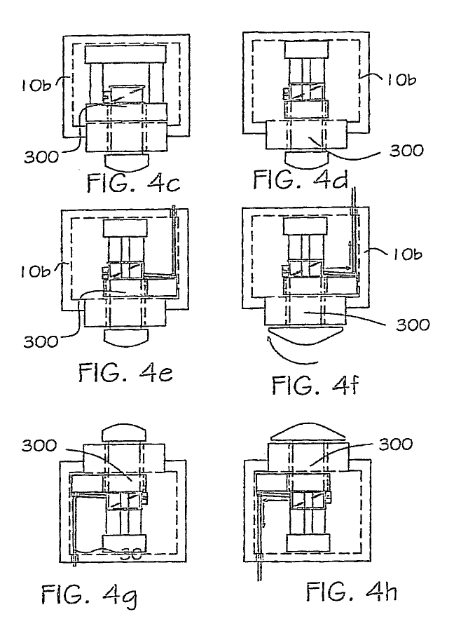

FIGS. 4a-4b shows a top view and side view of one embodiment of a locking mechanism 300. The drawing illustrates a locking leg 30 having a locking leg shaft 31. The locking leg shaft 31 protrudes through a collar 40 having a collar orifice 41 and an internal locking leg 43 having an internal locking leg well 44. The locking leg shaft 31 protrudes above the internal locking leg 43 where a vertical slippage prevention means 34 holds the locking leg 30 in the assembly. The vertical slippage prevention means can also act as a coupling means attachment means 35. A torsional return means 47 applies a force to the locking leg shaft 31. Spacers 37 and a top bar 39 may also be connected to the internal locking leg 43 as shown to fill the vertical void inside the lower corner fitting 10b of a container 1. A guiding eye 24 is a part of the guiding eye attachment means 49 which is connected to the internal locking leg 43. When the vertical coupling means 25 enters the lower corner fitting 10b of a container it can pass through the guiding eye 24 and can be connected to the locking leg shaft 31 as illustrated in this embodiment by being secured to the coupling means attachment means 35. The coupling means attachment means 35 can also be used to connect horizontal coupling means 45 to locking legs 30 as is shown in FIGS. 6a-6b. As discussed above, when an actuating unit 100 is engaged, a force is applied to the vertical coupling means 25. This force causes the locking leg shaft 31 and therefore the locking leg 30 to rotate, as is demonstrated in FIGS. 6a-6b. When the locking leg shaft 31 rotates to a position that aligns the locking leg 30 with vertically directed access slots 6, the container can be hoisted clear of the vertically directed access slot 6. Additionally, when the actuating unit 100 is disengaged, a torsional return means 47 will cause the locking leg shaft 31 and the locking leg 30 to rotate so that the locking leg 30 no longer aligns with the vertically directed access slots 6 thereby securing the container to a new base 5.

FIGS. 4c-4f illustrate how the above described embodiment of a locking mechanism 300 can be inserted into a lower corner fitting 10b and can be connected to a vertical coupling means 25. In FIG. 4c the internal and external components are aligned with the access slot 6 of the lower corner fitting 10b and inserted. In FIG. 4d the internal assembly is rotated around the locking leg shaft 31, thereby securing the locking mechanism 300 within the interior volume of the lower corner fitting 10b. FIGS. 4e-4f illustrate how the vertical coupling means 25 connects to the locking mechanism 300 and can cause the locking leg 30 to rotate.

FIGS. 4g-4h demonstrate how the locking mechanism 300 can be used as a locking mechanism in an upwardly facing access slot 6 such as when a corner fitting type device is utilized to secure containers to chassis, railroad cars or terminal decks.

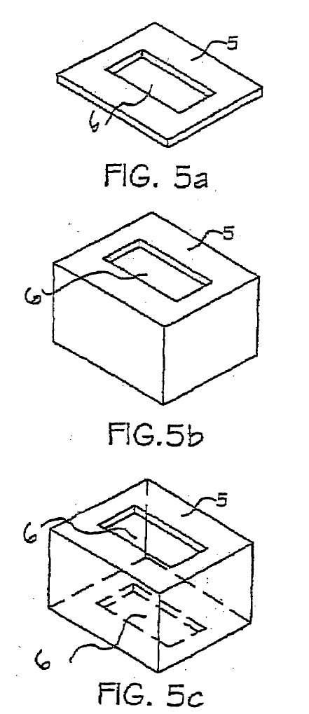

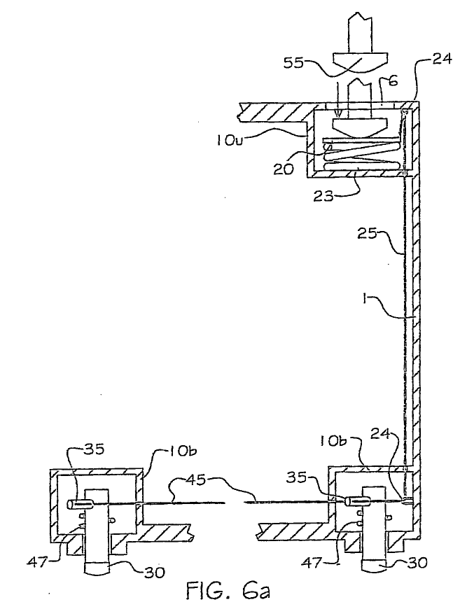

Referring to FIGS. 5a-5c, various bases 5 can be seen. Each variation of the base 5 has at least one vertically directed access slot 6 to receive a locking leg 30 of the present invention. A variety of base 5 designs may be utilized embodying the basic principal of the disclosed design. These bases 5 may be installed on ship decks, cargo holds, truck chassis, train cars, or wherever necessary.

As can be seen in FIG. 6a, a lifting spreader twist lock 55 is prepared to engage the upper corner fitting 10u of the container 1, through the vertically directed access slot 6. As described previously, a vertical coupling means 25 couples the compression plate 20 with the coupling means attachment means 35. The horizontal coupling means 45 couples a first lower corner fitting 10b with an adjacent lower corner fitting 10b on the same container 1. It can be seen that a torsional movement of the locking leg 30 of the first corner fitting 10b will impart a rotation on the second locking leg 30 located in an adjacent lower corner fitting 10b. When the lifting spreader twist lock 55 is disengaged from the upper corner fitting 10u of the container 1, the load is lifted from the compression plate 20, and the downward tension is reduced, allowing a torsional return means 47 to impart a rotational motion on the locking leg 30, causing it to be returned to the locked position.

Looking at FIG. 6b, a lifting spreader twist lock 55 is engaged in the upper corner fitting 10u of container 1, though the vertically directed access slot 6. The compression plate 20 is depressed and, in a manner previously described, imparts a rotational motion on the locking leg 30 of the first lower corner fitting 10b, causing it to move into the unlocked position. The horizontal coupling means 45, as a result, is tensioned, thus imparting a rotation on the second locking leg 30 located in another lower corner fitting 10b of container 1, causing it to be moved into the unlocked position. In this way, a single actuating unit 100 can cause multiple locking legs 30 of the corner fitting 10b located at each corner of the container 1 to move simultaneously into the locked or unlocked position.

While the present invention has been described with regards to particular embodiments, it is recognized that additional variations of the present invention may be devised without departing from the inventive concept.

What is claimed is:

1. A shipping container locking system comprising:
an upper housing, said upper housing being located at an upper corner of a shipping container, said upper housing having an interior volume, said upper housing having a bottom interior surface, said upper housing having a top face, said top face having an orifice formed therethrough, said orifice configured to receive a locking leg from an adjacent shipping container;
an actuating unit having a floor and wall surface, said floor having a top surface and bottom surface, said wall surface having an interior surface and exterior surface, said actuating unit being located within the interior volume of said upper housing, said floor surface being generally parallel to said upper housing bottom interior surface and said wall surface being generally perpendicular to said upper housing bottom interior surface;
a swivel extending perpendicularly to said actuating unit floor surface and said upper housing bottom interior surface, said swivel being located generally centrally about said floor surface;
a lower housing, said lower housing being located at a lower corner of said shipping container, said lower housing having an interior volume, said lower housing having a bottom face, said bottom face having an orifice formed therethrough;
a collar, said collar protruding through said bottom face orifice, said collar having an orifice formed therethrough;
a locking leg, said locking leg protruding through said collar orifice, said locking leg having a cylindrical section and an elongated base, said elongated base being connected to said cylindrical section, a central axis of said cylindrical section being normal to a top surface of said elongated base, said cylindrical section communicating between said collar orifice and said elongated base, said elongated base being located outside of said collar;
a vertical coupling means, said vertical coupling means mechanically connecting said actuating unit with said cylindrical section;
a torsional return means, said torsional return means being located within said interior volume of said lower housing, said torsional return means communicating elastically between said cylindrical section and said collar, said torsional return means having a torsional force that is applied to said cylindrical section about said central axis;
wherein a load is applied to said interior wall surface of said actuating unit rotating said actuating unit around said swivel;
and wherein said vertical coupling means is actuated by the torsional movement of said actuating unit; said actuating unit imparting a generally vertical motion on said vertical coupling means;
and wherein said vertical coupling means imparts a rotational motion on said cylindrical section, rotating said cylindrical section and said elongated base.

2. The shipping container locking system of claim 1 wherein said shipping container locking system is installed on a plurality of corners on said shipping container.

3. The shipping container locking system of claim 1 wherein said load applied to interior surface of said actuating unit is a lifting spreader twist lock.

4. The shipping container locking system of claim 1 wherein said elongated leg is inserted into a receiving chamber of another shipping container, said rotational motion causing said elongated leg to lock within said receiving chamber.

5. The shipping container locking system of claim 1 includes a second shipping container locking system which is installed on a second upper corner of said shipping container and a second lower corner of said shipping container; wherein at least one tine well is interposed between the lower corners of said container; wherein a horizontal coupling means extends between the lever arm of the first locking system and the lever arm of the second locking system, intersecting said tine well; and wherein a tine of a lifting device is inserted into said tine well, imparting a deflection in said horizontal coupling means, and said horizontal coupling means imparts a rotational motion on the lever arms, rotating said cylindrical section and said elongated base.

6. The shipping container locking system of claim 5 wherein said rotational motion on the lever arms causes said locking leg to rotate into an unlocked position.

7. The shipping container locking system of claim 1 wherein said actuating unit includes a swivel plate, said swivel plate having a top surface and bottom surface being generally parallel with said upper housing interior bottom surface, said swivel extending perpendicularly to said swivel plate top surface.

8. The shipping container locking system of claim 1 wherein said actuating unit is comprised of a plurality of studs, said studs extending in a generally upward direction from said floor top service.

9. The shipping container locking system of claim 1 wherein said collar is comprised of an internal locking leg and a bottom collar, said internal locking leg being located within said lower housing interior volume and said bottom collar being located within and protruding from said bottom face orifice.

10. The shipping container locking system of claim 1 wherein said torsional return means is located within an interior volume of said collar
